(19) United States
(12) Patent Application Publication
(10) Pub. No.: US 2010/0289921 A1
(43) Pub. Date: Nov. 18, 2010

(54) DIGITAL CAMERA HAVING LAST IMAGE CAPTURE AS DEFAULT TIME

(76) Inventors: Thomas A. Napoli, Rochester, NY (US); Timothy J. White, Webster, NY (US)

Correspondence Address: Peter P. Hernandez;Patent Legal Staff, Eastman Kodak Company, 343 State Street, Rochester, NY, 14650-2201, US

(21) Appl. No.: 12/465,698

(22) Filed: May 14, 2009

(51) Int. Cl. H04N 5/76

(52) U.S. Cl. 348/231.5; 348/E05.024

(57) ABSTRACT

A digital camera includes a clock for keeping time; memory for receiving and storing time updates; and a processor for directing the time updates to be recorded in the memory upon occurrence of any of a plurality of camera operations; wherein a default time for the clock is dynamically updated as the time of the last recorded time in the memory.

### FIELD OF THE INVENTION

The present invention is directed to digital cameras having a real-time clock and, more particularly, to such digital cameras having a real-time clock with a default setting.

### BACKGROUND OF THE INVENTION

Currently, digital cameras include a clock that keeps real-time for permitting various timing features to be performed. For example, the date and time that an image is captured is recorded and associated with each captured image. This can be done by storing Date/Time metadata in the image file. For example, the well-know Exif image file format includes a DateTimeOriginal tag, which can be used to store the date and time that each image was captured. The DateTimeOriginal tag can be read by various computer software photo applications, such as Kodak EasyShare software, in order to display the captured images in chronological order or to retrieve images captured on a particular date, or during a particular time period.

However, after an extended power loss, the real-time clock stops functioning. An extended power loss can occur when the batteries are removed from the digital camera for several minutes or longer, or when depleted batteries remain in the digital camera for several minutes or longer. When power is restored, the date and time are set to a default value, such as the original manufacturing time and date, and the user is prompted to set the date/time to the current value. Users often bypass this prompt and the default date and time setting is applied. As a result, the date and time metadata stored with subsequently captured images is not only incorrect, it is set to an earlier date than the date stored with the images captured prior to the extended power loss. Therefore, the images appear out of chronological order when displayed, with the more recently captured images appearing to have been captured prior to those that were captured before the extended power loss.

US Patent Application 2005/0110880 to Parulski et al. discloses a digital camera with a real-time clock for recording and associating the real-time clock value with the captured images. A communication is established between the digital camera and a separate electronic device, such as a computer, also with a real-time clock. A predetermined time-difference correlation is made between the time of the real-time clock of the digital camera and the real-time clock of the computer, and the time recorded with the captured images is modified based on the time-difference correlation.

U.S. Pat. No. 6,910,147B2 discloses a digital recording apparatus in communication with a computer, and the computer “provides a date and time reference to which to relate the digital recording apparatus' real time clock.”

Although the currently known and used mechanisms for keeping time in electronic devices are satisfactory, the present invention ascertained that shortcomings arise when default settings are used with captured images after an extended power loss. In this regard, if the images and their associated recorded times use the original manufacturing date as the default time when resetting the real-time clock, the chronological order in which the images are sequenced will be inaccurate.

Secondly, using other separate devices is not always desirable since access to a second device may restrict how the digital camera is used, and since the date/time setting of the second device may also be incorrect.

Consequently, a need exists for improving the operation of the real-time clock in a digital camera.

### SUMMARY OF THE INVENTION

The present invention is directed to overcoming one or more of the problems set forth above. Briefly summarized, according to one aspect of the invention, the invention resides in a digital camera having a clock for keeping time; memory for receiving and storing time updates; and a processor for directing the time updates to be recorded in the memory upon occurrence of any of a plurality of camera operations; wherein a default time for the clock is dynamically updated as the time of the last recorded time in the memory.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECT OF THE INVENTION

The present invention has the advantage of keeping images in the correct chronological order, if the clock ceases running as a result of depleted batteries or the like, so that time order is preserved.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of a camera of the present invention;

FIG. 2 is a block diagram illustrating the clocking operations of the digital camera; and

FIG. 3 is flowchart illustrating the operation of the clock resetting of the camera of the present invention.

### DETAILED DESCRIPTION OF THE INVENTION

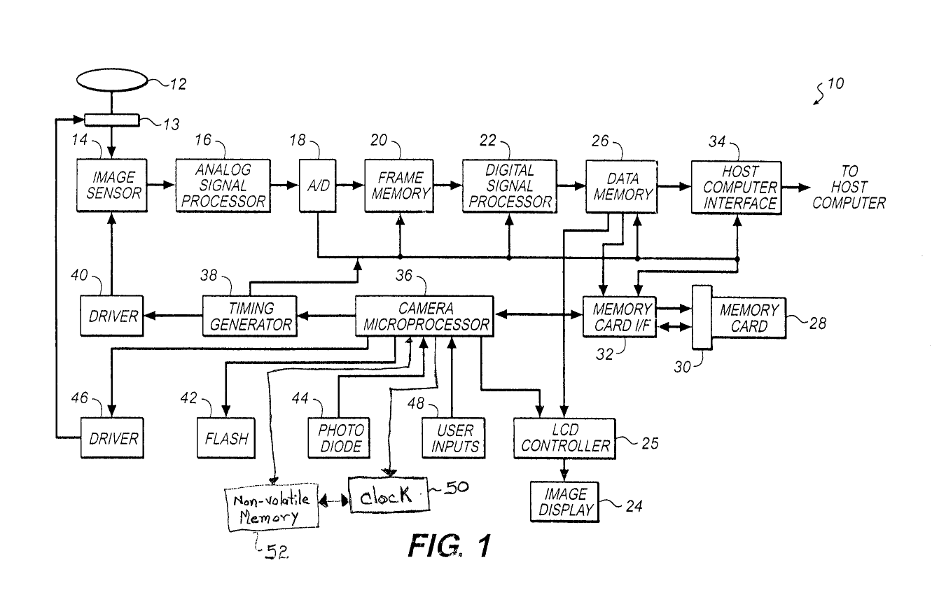

Referring to FIG. 1, a block diagram of an exemplary digital camera 10 in accordance with the preferred embodiment of the present invention is shown. As shown in FIG. 1, the digital camera 10 includes a lens 12 which directs image light from a subject (not shown) through an aperture/shutter controller 13 upon an image sensor 14 having a discrete number of photosensitive sites or pixels arranged in a two-dimensional array to form individual photosensitive sites corresponding to the pixels of the image. The image sensor 14 can be a charge coupled device (CCD) sensor or a complementary metal oxide semiconductor (CMOS) imager, both of which are well known in the art. The photosensitive sites of the image sensor 14 collect charge in response to incident light. Each photosensitive site is overlaid with a color filter array (CFA), such as the Bayer CFA described in commonly-assigned U.S. Pat. No. 3,971,065. The Bayer CFA has 50% green pixels in a checkerboard pattern, with the remaining pixels alternating between red and blue rows. The photosensitive sites respond to the appropriately colored incident light illumination to provide an analog signal corresponding to the intensity of illumination incident on the photosensitive sites.

The analog output of each pixel is amplified and analog processed by an analog signal processor (ASP) 16 to reduce the image sensor's output amplifier noise. The output of the ASP 16 is converted to a digital image signal by an analog-to-digital (A/D) converter 18, such as, for example, an 8 bit A/D converter which provides an 8 bit signal in the sequence of the Bayer CFA.

The digitized image signal is temporarily stored in a frame memory 20, and is then processed and compressed by a digital signal processor (DSP) 22. The image processing typically includes white balance, color correction, tone correction, and image sharpening. The DSP 22 may also decimate (or re-sample) the digitized image signal for each still image to produce a thumbnail image having fewer pixels (i.e., lower resolution) than the original captured image as described in commonly-assigned U.S. Pat. No. 5,164,831 to Kuchta et al. The image file containing both the full resolution image and the thumbnail image is stored in a data memory 26, and then transferred through a memory card interface 32 to a memory card 28 that is present in a memory card slot 30 of the digital camera 10. The thumbnail image is also sent to an image display 24 through an LCD controller 25 where the user can view the image. Although the display is shown as an LCD display, OLED displays may also be used. The image display 24 includes a conventional arrangement for displaying the captured image. The image display 24 may, alternatively, utilize many other types of raster image displays, including miniature CRT's, organic light emitting diode (OLED) arrays, or field emission displays.

The memory card 28 can be a flash memory card adapted to one of the numerous memory card format standards, such as the well-known PC card, Compact Flash, SmartMedia, MemoryStick, MMC or SD memory card formats.

Electrical connection between the memory card 28 and the digital camera 10 is maintained through a card connector (not shown) positioned in the memory card slot 30. The memory card interface 32 and the card connector provide, e.g., an interface according to the aforementioned PCMCIA card or CompactFlash interface standard. The image file may also be sent to a host computer (not shown), which is connected to the digital camera 10 through a host computer interface 34.

In alternative embodiments, other types of memory, such as internal Flash memory chips, magnetic memory, or optical memory, can be used in place of the memory card 28.

In operation, a camera microprocessor 36 receives user inputs 48, such as from a shutter release (not shown), and initiates a capture sequence by signaling a timing generator 38. The timing generator 38 is connected generally to the elements of the digital camera 10, as shown in FIG. 1, for controlling the digital conversion, compression, and storage of the image signal. The camera microprocessor 36 also processes a signal from a photodiode 44 for determining a proper exposure, and accordingly signals an exposure driver 46 for setting the aperture and shutter speed via the aperture/shutter controller 13 and triggers a flash unit 42 (if needed). The image sensor 14 is then driven from the timing generator 38 via a sensor driver 40 to produce the image signal. The user inputs 48 are used to control the operation of the digital camera 10 in a well-known manner.

A clock 50 provides real-time time keeping for the digital camera 10. When an image is captured, the microprocessor 36 reads the date and time of capture as indicated by the real-time clock 50 and stores and associates it with the particular captured image in the memory card 28, such as by storing the date and time in the DateTimeOriginal tag within the Exif image file which contains the captured image data. This enables the captured images to have its time of capture stored with the image which is beneficial when chronological ordering of the images or the like is desired.

The camera 10 of the present invention also includes non-volatile memory 52 that is periodically dynamically updated with the date and time from the clock 50, when a particular camera operation occurs. For example, when an image is captured, the current date and time from the clock 50 can be stored in non-volatile memory 52 as directed by the microprocessor 36. This is only one example of a particular camera operation in which the clock 50 can update the non-volatile memory 52. In some embodiments, the clock is updated as the camera is being powered down, or on a regular basis (e.g. once per minute) whenever the camera is powered on, or whenever an image is edited by the camera 10. It is understood that the non-volatile memory 52 can be included as part of the camera microprocessor 36, memory card 28, or one of the other camera components.

In alternative embodiments, the functions of the camera microprocessor 36, digital signal processor 22, non-volatile memory 52, and clock 50 can be provided by custom circuitry (e.g. by one or more custom integrated circuits (ICs) designed specifically for use in digital cameras), or by a combination of programmable processor(s) and custom circuits.

Upon start-up after a power loss, the user is prompted, using a graphical user interface displayed on image display 24, to input the current date and time using user inputs 48, or to instead select the default setting. In the present invention, the default setting is set to the date and time of the last recorded time of a camera operation, which was previously stored in non-volatile memory 52. Therefore, if the user does not input a time, the default setting of the date and time stored in non-volatile memory 52 is automatically input as the new date and time for the clock 50, and the clock 50 starts its real-time time counting based on this stored value rather than on a factory default setting as its starting point. Consequently, any image captured after this will not have the exact date and time stored and associated with it. But it will have a date and time which provides the correct chronological order. The date and time stored will be earlier than the actual date and time. The period of this “error” is equal to the elapsed time between when date and time was stored in non-volatile memory 52 (prior to the extended power loss) and when the user set the real-time clock to the default setting. The error period can range from a few minutes to a much longer period of time, depending on whether the user was slowly changing the camera batteries, or whether the camera 10 was sitting unused for many months while the batteries slowly depleted.

In some embodiments, the error period can be corrected as described in US Patent Application 2005/0110880 to Parulski et al., the disclosure of which is incorporated herein by reference. For example, the method described in paragraph 43 of Parulski, et. al. can be used to store a clock status value in the non-volatile memory 52. This clock status value is incremented each time the real-time clock is reset, and is stored as metadata in the image file. Each image having the same clock status value metadata will have the same error period. Therefore, if the approximate error period (e.g. 14 days and 8 hours) is determined for one of the images (such as by knowing that the image was captured on Christmas morning, for example), the date and time of all of the other images having the same clock status value can be corrected by applying the same error period correction (e.g. automatically adding 14 days plus 8 hours to the date and time of these other images).

In alternative embodiments, the digital camera 10 can also capture motion video images. In alternative embodiments, the digital camera 10 can include other functions, such as those provided by including the functions of a digital music player (e.g. MP3 player), a mobile telephone, and/or a programmable digital assistant (PDA).

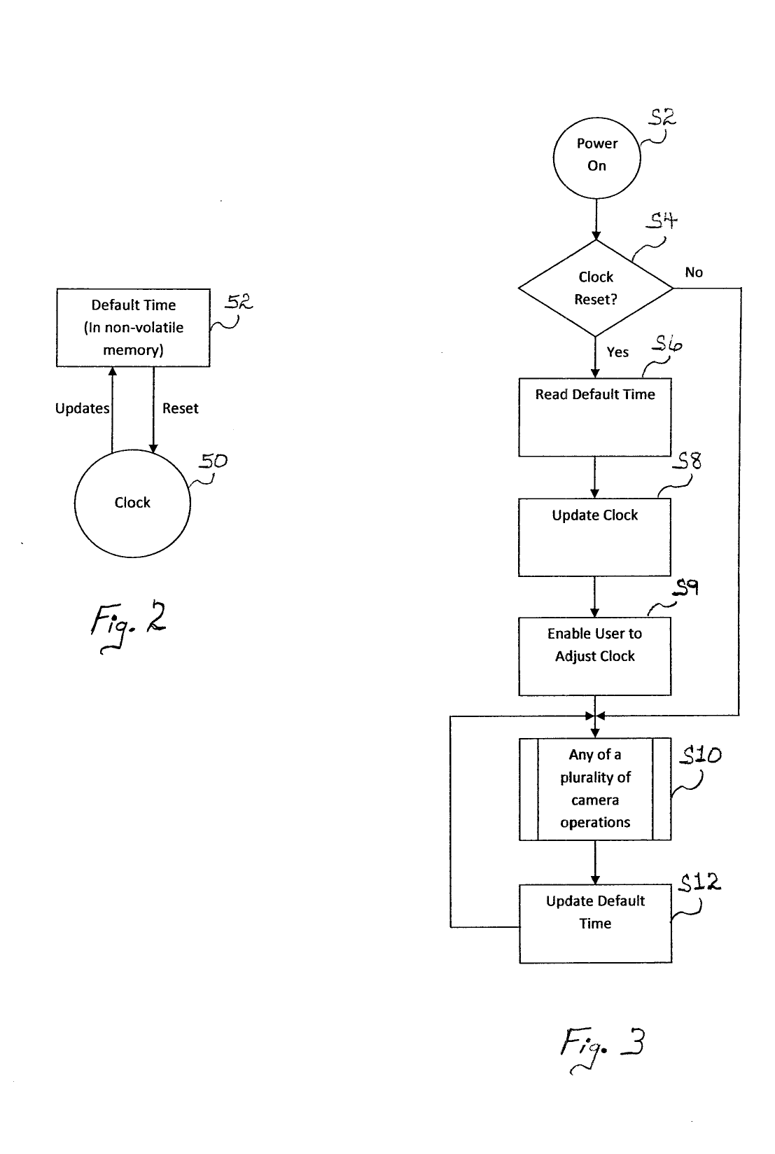

Referring to FIG. 2, there is shown a block diagram of the camera 10 of the present invention illustrating the portions that are responsible for the default setting. In this regard, the clock 50 keeps real-time date and time, and the clock reset value in non-volatile memory 52 is initially set as the date and time of manufacture at the factory. During the lifetime of the camera 10, the clock 50 may lose its timing capabilities for various reasons. In this case, the clock 50 will need to be reset either manually or with the default setting. If the user manually resets the clock 50, the microprocessor 36 directs the date and time that was manually input to also be stored in the non-volatile memory 52 with this date and time. This time now becomes the default time setting in non-volatile memory 52. It is instructive to note that the microprocessor 36 also directs the default setting to be automatically updated upon the occurrence of any one of a number of camera operations (i.e., dynamically updated) and that manual reset is only one example. Further instances of camera operations that will cause the clock reset value in non-volatile memory 52 to be reset are when an image is captured, power down and editing of an image. Therefore, the default setting stored as the clock reset value is constantly updated during the lifetime of the camera 10. Consequently, when the default setting is selected to update the clock 52 after it loses track of time, the current value in non-volatile memory 52 is used which is the last time the clock reset value was updated and recorded in non-volatile memory 52.

FIG. 3 provides a flow diagram of the present invention illustrating the clock resetting. It is noted that the flowchart illustrates only the pertinent functions related to the clock resetting of the present invention and does not illustrate the various other functions that the camera performs. Upon powering the camera on S2, the processor 36 checks to verify if the clock needs resetting S4. If the clock does not need resetting, the processor continuously verifies if any of a plurality of camera operations are performed S10. If any of the operations are performed, the processor 36 directs the time to be stored in non-volatile memory 52 so that it may be used as the default setting in the future.

If the clock 50 needs resetting S4, the default value is read S6 from non-volatile memory 52 and the clock is updated S8 with this default time. This default time is then displayed on the image display 24. The user can adjust this default value S9 to the proper time using the user inputs 48. Because the default value may be close to the proper time (e.g., it may be in error by only a few hours or a few days), it is much faster and easier for the user to adjust the time to be the proper time compared to the prior art situation where the clock is set to the factory default time. For example, the current time could be May 4, 2009 at 10:17 am while the factory default time could be Jan. 1, 2008. If the user took many pictures the previous day and depleted the batteries (thus causing an extended power loss), the default time could be May 3, 2009 at 4:23 pm. When the clock 50 is reset S4 to the default value S6, the displayed time will be May 3, 2009 at 4:23 pm. Thus, the month and year will be correct, and the user need only advance the date (by one day) and set the proper time. If the extended power loss was only a few minutes; for example as the user changed batteries after taking some pictures, it is unlikely that the date and hour setting will be proper, and only the minutes will need to be advanced. This makes it much easier for the user to set the proper time. The processor then monitors any of the plurality of camera operations S10 and the default time is updated S12 continuously upon the occurrence of any of the plurality of events.

It is noted the flowchart illustrates a preferred embodiment. As stated above, the clock 50 may update default setting in non-volatile memory 52 periodically without the occurrence of any one of the predetermined operations.

The invention has been described in detail with particular reference to certain preferred embodiments thereof, but it will be understood that variations and modifications can be effected within the spirit and scope of the invention.

### PARTS LIST

10 Camera
12 Lens
13 aperture/shutter controller
14 Image Sensor
16 Analog Signal Processor
18 A/D converter
20 Frame Memory
22 Digital Signal Processor
24 image display
25 LCD controller
26 Data Memory
28 Memory card
30 Memory card slot
32 Memory card interface
34 Host Computer Interface
36 Camera Microprocessor
38 Timing Generator
40 Driver
42 Flash
44 Photodiode
46 Driver
48 User Inputs
50 Clock
52 Non-volatile Memory

What is claimed is:

1. A digital camera comprising:
(a) a clock for keeping time;
(b) memory for receiving and storing time updates; and
(c) a processor for directing the time updates to be recorded in the memory upon occurrence of any of a plurality of camera operations; wherein a default time for the clock is dynamically updated as the time of the last recorded time in the memory.

2. The digital camera as in claim 1, wherein the memory module is non-volatile memory.

3. The digital camera as in claim 2, wherein the camera operation is time of the last captured image.

4. The digital camera as in claim 2, wherein the camera operation is time of the last power down.

5. The digital camera as in claim 2, wherein the camera operation is time of the last image edit.

6. The digital camera as in claim 2, wherein the camera operation is manual reset.

7. The digital camera as in claim 1, wherein, when clocking operations are restored after the clock temporarily ceases keeping time, the clock is reset to the default time.

8. The digital camera as in claim 7, wherein the clock keeps continuous time after being reset and uses the time of the continuously running clock to be recorded and associated with subsequently captured images.

9. A digital camera comprising:
(a) a clock for keeping time;
(b) memory for receiving and storing time updates; and
(c) a processor for directing the time updates to be recorded in the memory at any time interval; wherein a default time for the clock is dynamically updated as the time of the last recorded time in the memory.

10. The digital camera as in claim 9, wherein the memory module is non-volatile memory.

11. The digital camera as in claim 9, wherein, when clocking operations are restored after the clock temporarily ceases keeping time, the clock is reset to the default time.

12. The digital camera as in claim 11, wherein the clock keeps continuous time after being reset and uses the time of the continuously running clock to be recorded and associated with subsequently captured images.
